(19) United States
(12) Patent Application Publication
(10) Pub. No.: US 2015/0347946 A1
(43) Pub. Date: Dec. 3, 2015

(54) STORE OPENING COCKPIT FOR REAL-TIME PREPARATION, SIMULATION AND EXECUTION OF MERCHANDISE SUPPLY FOR GRAND OPENING EVENTS

(71) Applicant: Timo Vogelgesang, Blieskastel-Biesingen (DE)

(72) Inventor: Timo Vogelgesang, Blieskastel-Biesingen (DE)

(21) Appl. No.: 14/291,675

(22) Filed: May 30, 2014

(51) Int. Cl. G06Q 10/06

(52) U.S. Cl. CPC G06Q 10/06315

(57) ABSTRACT

A system and method including receiving a selection of one or more store parameters, receiving a selection of a merchandise template, the merchandise template specifying a product, displaying a retail space based on at least one selected store parameter and the selected merchandise template, determining a quantity of the product based on at least one store parameter, determining availability for the quantity of the product using an in-memory database, and displaying availability information. An advantage of such a system and method is to provide real-time analysis and results of “what-if” scenarios input by a user.

### BACKGROUND

The present disclosure generally relates to methods and systems for utilizing retail space, and more particularly, to electronic applications that facilitate the operations of the retail space during a grand opening event or other sales period.

As commerce becomes increasing global, retailers desire to open new store locations worldwide. In order to increase their market-share in existing and new markets, it is not unusual for a well-established retailer to open hundreds of new stores during the course of one year. Growing retailers may be especially bullish in emerging markets, such as China or Brazil, where numerous stores may be launched within a short period of time, just a few months or even weeks.

Many retailers target select city locations with so-called “flagship” stores. Such flagship stores are often found in well know cities and shopping districts, such as Fifth Avenue in New York, Bond Street in London, Avenue Montaigne in Paris, and Ginza District in Tokyo. The opening of a flagship store is typically a momentous event with the members of the media, politicians, actors, and fashion models frequently in attendance. In addition, it is not uncommon for hundreds or even thousands of potential shoppers to eagerly await the opening of a new store, and to line-up for hours in advance of the first opening of the flagship store's doors.

Because first impressions matter, a store's grand opening has the potential to attract or alienate a potential new customer base. Therefore, a new store should be completely ready, nicely arranged, fully stocked, and adequately staffed during the store's opening event. Among the challenges posed by a grand opening, merchandising and logistics problems continue to plague retailers. On grand opening day, inventory of a flagship store may have to be replenished on an hourly basis to ensure that every shopper is provided with an optimal shopping experience.

Although many types of inventories may be easily stocked, some inventory types present additional challenges. For example, inventories of high fashion retailers may change frequently to accommodate ten (or even more) seasons and collections during the course of one year. Today, high fashion retailers desire to continuously offer new styles to consumers when they return to stores after just a few weeks or even only days. Furthermore, reordering previous collections may not be possible since manufacturers may be located at more remote locations in the Far East and may already be producing styles for upcoming collections and seasons. As a result, complex analysis is often needed to determine inventory for a grand opening event when the merchandise includes fast selling assortments.

Accordingly, embodiments of the present disclosure facilitate operations of the retail space during a store's grand opening event or other sales period.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 illustrates a method for mobile retail optimization according to an example embodiment of the present disclosure;

FIG. 2 illustrates a system level architecture that depicts the interaction between a remote electronic device and a backend system according to an example embodiment of the present disclosure;

FIG. 3A illustrates a representative view of a portable electronic device having a retail application according to an example embodiment of the present disclosure;

FIG. 3B illustrates an architectural view of the retail application according to an example embodiment of the present disclosure;

FIG. 4 illustrates a method for displaying a retail space according to an example embodiment of the present disclosure; and

FIG. 5 illustrates a representative architecture of a portable electronic device according to an example embodiment of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touchscreen and/or other input/output devices. In the discussion that follows, a portable communications device is used as an example embodiment. It should be understood, however, that the user interfaces and associated methods may be applied to other devices, such as personal computers and laptops, which may include one or more other physical user-interface devices, such as a keyboard and/or mouse.

The portable communication device may support a variety of applications, such as telephone, text messenger, and retail applications. The various applications that may be executed on the device may use at least one common physical user-interface device, such as a touchscreen. One or more functions of the touchscreen as well as corresponding information displayed on the device may be adjusted and/or varied from one application to another and/or within a respective application. In this way, a common physical architecture of the device may support a variety of applications with user interfaces that are intuitive and transparent. In the discussion that follows, a retail application is used as an example embodiment, but it should be understood that the user interfaces and associated methods may be applied to other applications.

Embodiments of the present disclosure are directed to facilitating operations of the retail space during a store's grand opening event. The described methods and systems utilize several types of information that include, but are not limited to, store layouts, product placement, product displays, product turnover rates, expected number of customers, product availability, product transit data, etc. Retailers can utilize the mobile retail application to access local and remotely stored information. A retail calculation engine analyzes these data to provide expected sales data for one or more products in real-time so that adequate inventory may be supplied.

A retail application that allows the user to customize a store layout, including one or more product displays, is provided. When the store layout and/or product collections are changed, the retail space application determines the feasibility of the user proposed store layout based on data provided by a business backend system. Using a mobile device such as a tablet, the retail space application may illustrate sections of the retail space and simultaneously provide real-time analysis.

A user viewing a retail display may vary the store layout and its inventory. Using a user-interface of the portable communication device, a user may change one or more product arrangements and determine the feasibility for each alternative arrangement. In the case of a touchscreen, the store arrangements may be changed by dragging the store sections and product displays illustrated on the touch screen.

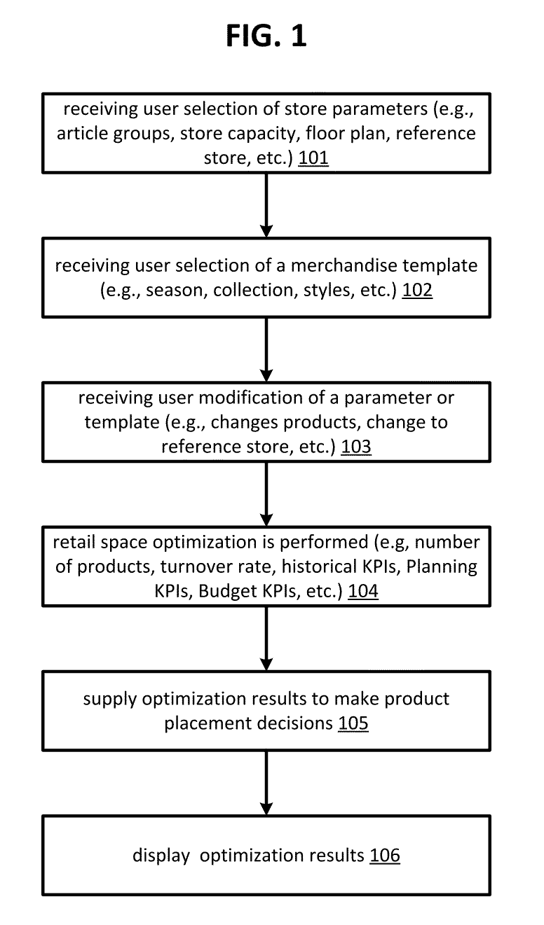

FIG. 1 illustrates a method for mobile retail optimization according to an example embodiment of the present disclosure.

At step 101, a backend system, such as a server, receives a user selection of one or more store parameters. Several store parameters may be specified by a user, and can be selected to accommodate different arrangements of the retail floor space. Some example store parameters include store capacity (e.g., total square footage), article groups (e.g., men's wear, women's wear, shoes, etc.), store capacity designated for each article group, location of each article group within the retail space (e.g., store floor plan, or use of floor and/or quadrant), and a reference store. Here, a reference store may designate parameters of another already existing store having a similar design, revenue model, shopper behavior patterns, and expected sales as the store being designed.

The retail application may generate and display a visual representation of a default retail floor space. For example, the default retail space may be generic based on the type of retail store being modeled (e.g., department, convenient, clothing, etc.), or may be specifically modeled on the retail store of a specific retailer. Within the default retail space, the user may add one or more product displays. Product displays may be added, deleted, or modified in accordance with selections from the user.

In some embodiments, the retail application may initially prompt a user for a login name and login password. The login name and login password may then be used to identify individual users associated with the business backend system.

At step 102, the backend system receives a user selection of a merchandise template. A merchandise template may be an inventory indicator that specifies the product line-up for the grand opening event or other sales period. The merchandise template may indicate attributes of one or more products available to display including product type, product season, product collection, related products, number of products displayed, as well as the arrangement of items within a product display. For example, a merchandise template may indicate a product display that may require a predetermined square footage and include a certain number of pegs or shelves such that a particular number of items may be displayed. In another example, a predefined variety of products may be included in a merchandise template. Templates may be retailer, store, or manufacturer specific.

Here, when a user selects that a particular product for the grand opening event or other sales period, the availability of the product is checked by the backend system in real-time. For example, when a particular product is selected, the needed inventory may be calculated based on expected sales data. Needed inventory may further be compared to available inventory.

For example, product stock may be in manufacturer or retailer warehouses, in transit by train, ship, or truck from manufacturers, distributors, or the retailer, stocked in other stores, and/or available from other sales channels, such as online or wholesale channels. In some instances, a minimum availability of colors and sizes of a particular product may also be checked. As a result, scenarios can be avoided where only a few colors or a few sizes are available during the grand opening event of a store. Thus, customer frustration resulting from an unavailable size or color of a particular product may be avoided.

Next, at step 103, the backend system receives a user modification of a store parameter or merchandise template. In other words, when a user, at a remote electronic device, navigates the retail application and modifies a store parameter or merchandise template, the backend system receives and stores changes made. By modifying a parameter or template, an update to the data provided by the backend system to the retail display may be triggered. Typically, a user opens the retail application to view and/or modify (add, delete, change, etc.) one or more product displays of the retail floor space. For example, the user may change one or more variables such as the product collection, number of products displayed, turnover rate, etc. As a user changes store parameters and/or merchandise templates, the calculated feasibility as well as other data also displayed to the user may also be updated. For example, an alert may be displayed to the user indicating that inventory is unavailable or that the proposed product line-up requires more floor space that is available in the store floor plan.

As the retail application provides simulation and calculation results in real-time, a user may modify a store parameter or merchandise template to perform “what-if” analysis for multiple contingencies or scenarios. For example, a user may vary product line-ups, sources of available inventory, features of the reference store, store capacity, article group capacity, or the budget of the new store. In another example, a store owner may decide between a large rack displaying few expensive products having a high profit per item and moderate turnover rate, or a small rack displaying inexpensive goods having a lower profit per item and a high turnover rate.

After each recalculation of merchandise allocation triggered by a what-if analysis, the retail application may display the effect(s) of the modification in a graphical- and/or list-oriented format and thereby enable a comparison with planned capacities and budgets. As a result, a user may apply a trial and error method to achieve the desired results by implementing multiple what-if analyses. For example, a user may implement multiple what-if scenarios for different article groups. In another example, a user may compare expected sales data (or another metric) to evaluate and compare multiple what-if scenarios.

The steps of setting store parameters and/or merchandise templates may be performed initially when installing or first using the retail application. For example, the layout may be initially determined based on the layout of the reference store. Afterwards, a user may add, delete, or modify store parameters and product displays as desired.

As discussed above, the retail application illustrates a retail space and product display superimposed data. As a user changes inventory, product displays and placement, the retail application simultaneously updates the illustrated data to account for the changes made by the user. Of particular interest to the retailer would be the updated feasibility data for a particular product line-up.

At step 104, the backend system receives a user request, from the remote electronic device, to perform retail optimization. The request includes, for example, a message indicating that retail optimization should be performed based on user selected store parameters and merchandise templates. One or more metrics or key performance indicators (KPIs) may be used to perform retail optimization, including historical KPIs (e.g., based on historical sales data and historical stock time series), forecast KPIs (e.g., originating from predictive analytics), planning KPIs (e.g., originating from merchandise planning), and budget KPIs (e.g., originating from store planning). As historical data is unavailable for a new store, data corresponding to one or more reference stores may be used.

Upon receipt of the request, the backend system can determine the availability of the desired merchandise and other items, such as product displays, to calculate the feasibility to the desired grand opening arrangement. At step 105, optimization results are supplied to a user's portable electronic device. Lastly, at step 106, optimization results are displayed by the retail application. The backend system supplies the results to the remote electronic device so that a user can make inventory and product placement decisions. Generally, if the feasibility meets or exceeds the retailer's requirements, then the retailer will likely proceed to order the inventory and other items specified by the store parameters and merchandise template. Thus, a retail application that allows a user to accurately predict the feasibility of a grand opening event is provided.

The methods depicted in FIG. 1 generally occur in advance of a store's grand opening. However, the methods presented herein may also occur after the opening of a store. For example, a retailer launching a new product line-up at one or more store locations may use the techniques described above to ensure that adequate inventory is available for the new product's debut.

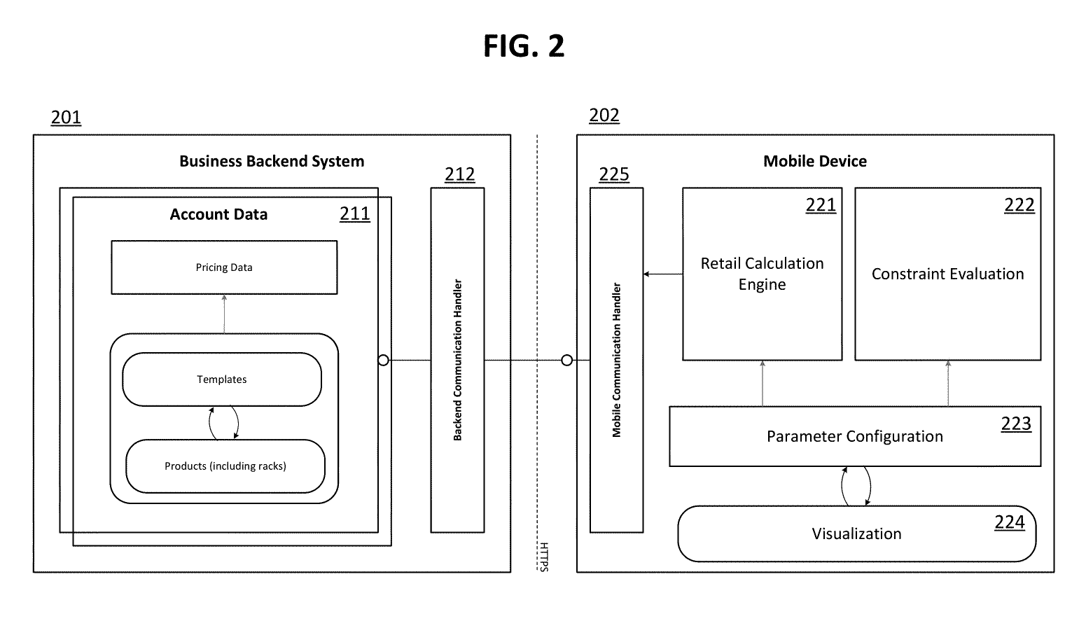

FIG. 2 illustrates a system level architecture that depicts the interaction between a remote electronic device and a backend system according to an example embodiment of the present disclosure.

As shown in FIG. 2, the system level architecture includes a business backend system 201 that is connected to a portable electronic device 202. The business backend system 201 can be connected to portable electronic device 202 using known or expected network technologies, such as wireless local area networks (WLAN) or wireless wide area networks (WWAN), some examples of which include WiFi, long term evolution (LTE), and the like. Backend communication handler 212 and mobile communication handler 225 manage communications functions for the business backend system 201 and mobile device 202, respectively.

Business backend system 201 includes one or more account databases 211 that store several types of information that can be queried by the mobile device 202. The account database 211 within business backend system 201 may include an in-memory database, such as the SAP® HANA in-memory database provided by SAP AG. Irrespective of the type of database being used, account database 211 stores standard and customized store layouts, reference store data, store parameters, product offerings, product availability information, product displays, product placement sales data, product turnover rates, product dimensions, profit per product sold, product sales trend, prices, etc. The data can be industry, geographic, or customer specific. Retailers may acquire rights to access different levels of information.

Also within business backend system 201, the account database 211 may be coupled to an allocation calculation engine. For example, the allocation calculation engine may be located within an in-memory database, such as SAP® HANA. Each execution of the allocation calculation engine may determine available quantities of products requested by a user.

Within the mobile device, parameter configuration module 223 can also store layout and selected product information. In addition, the parameter configuration module 223 also enables the user to modify and customize store parameters and merchandise templates. For example, the type of product displayed and product placement can be adjusted through the parameter configuration module 223. A constraint evaluation module 222 verifies that the user's proposed store parameters and merchandise templates are logistically feasible. For example, if a user wants to desires to stock 300 units of a particular product, but only 200 units are available, the constraint evaluation module may automatically adjust the quantity to the maximum possible or provide an error message to the user.

If the constraints are satisfied, the retail calculation engine 221 calculates expected sales data based on the store layout, available inventory, and expected product turnover which may be provided by the account database 211 of business backend system 201.

Visualization module 224 manages the display functions of the retail application. As described above, the retail application illustrates a retail floor space as well as product displays and corresponding data. When a user modifies a store layout, store parameter, merchandise template, or product display, the retail application also updates the illustrated data to account for the changes made by the user.

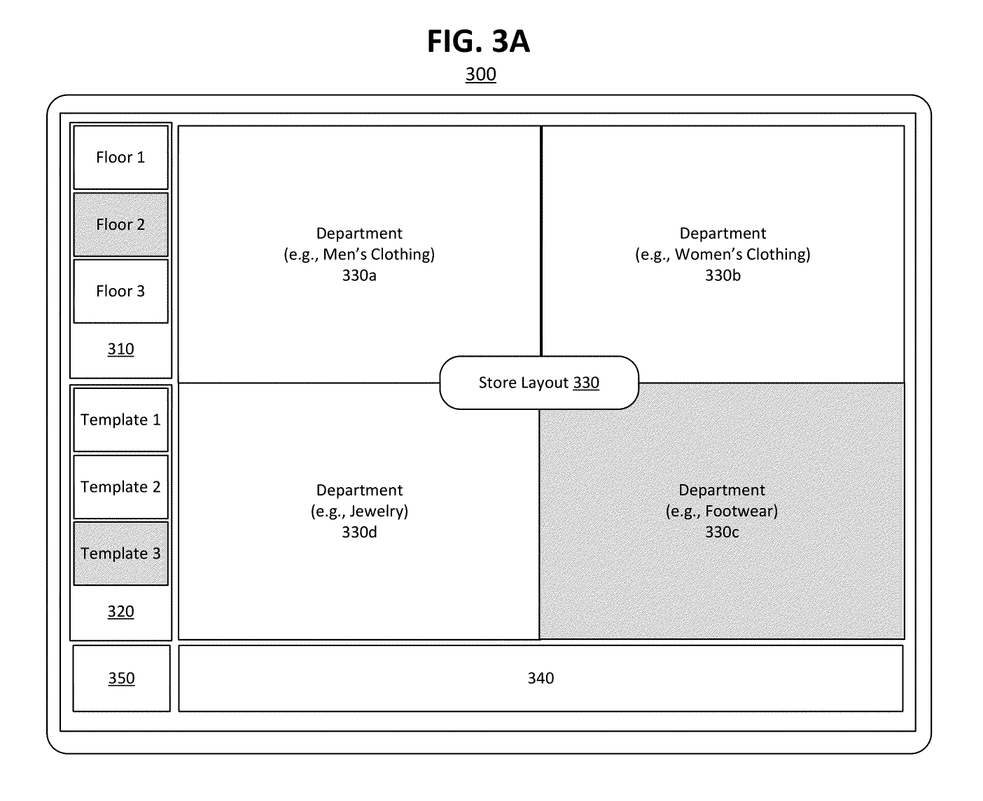

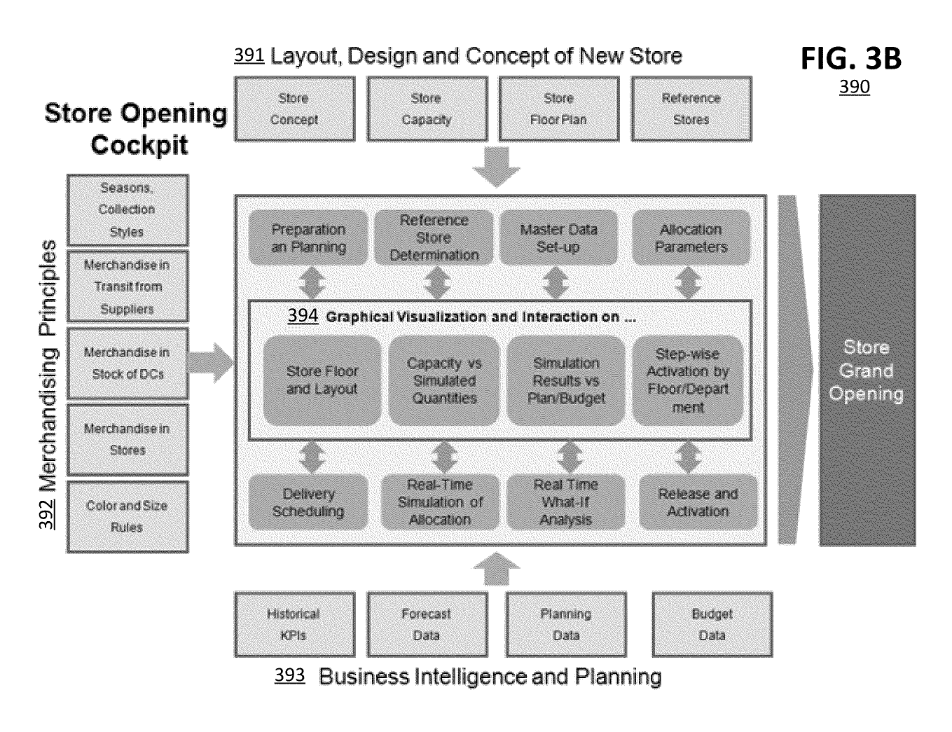

FIG. 3A illustrates a representative view of a portable electronic device having a retail application according to an example embodiment of the present disclosure. The representative view 300 includes floor selection menu 310, template selection menu 320, floor layout 330, and interactive display 340. In addition, floor layout 330 may include a plurality of departments 330a-330d (e.g., men's clothing, women's clothing, footwear, jewelry, etc.).

Floor selection menu 310 enables a user to select a floor for display in floor layout section 330. The selected floor may be highlighted to visually depict that a floor has been selected by the user. In the illustrated example floor selection menu 310, “Floor 2” has been selected for display in floor layout section 330.

Template selection menu 320 enables a user to select a merchandise template. As discussed above, a merchandise template may be an inventory indicator that specifies a product line-up. The merchandise template may indicate attributes of one or more products available to display including product type, product season, product collection, related products, number of products displayed, as well as the arrangement of items within a product display. A user may further select one or more merchandise templates for each of departments 330a-330d. In the illustrated example template selection menu 320, “Template 3” has been selected for department 330d.

In addition, floor layout 330 may include visual representations of the retail floor space as well as individual product displays superimposed on the retail space. For example, once the product display is superimposed on the retail space, the product display may be moved to various locations within the retail space. In some instances, a plurality of information displays (not shown) relating to product displays may be provided. Some examples of information displays include a number and type of product displayed, items per display unit, turnover rates, unit cost, sales price, and availability of inventory.

Within interactive display 340, the retail application provides simulation and calculation results in real-time as a user modifies the merchandise template or other store parameters to perform “what-if” analysis for multiple contingencies or scenarios. For example, a user may vary product line-ups, sources of available inventory, features of the reference store, store capacity, article group capacity, or the budget of the new store. After each recalculation of merchandise allocation triggered by a what-if analysis, the retail application may display the effect(s) of the modification in a graphical- and/or list-oriented format and thereby enable a comparison with planned capacities and budgets. For example, a user may compare expected sales data (or another metric) to evaluate and compare multiple what-if scenarios.

Lastly, there is a create order button 350 that enables a retailer to order and stock the items depicted by the proposed store layout and/or product display provided that the inventory of the desired product is available equal to or in excess of the retailer's desired inventory. For logistical reasons, the inventory of a new store typically arrives in segments, so that the new store can be stocked and arranged per floor, area, or article group. The retail application may include a step-wise or planned allocation of merchandise to the retail space. For example, the retail application may track inventory received by the new store so that a user may follow the filling-up of the store on a daily/hourly basis.

FIG. 3B illustrates an architectural view 390 of the retail application according to an example embodiment of the present disclosure. As shown in FIG. 3B, the architectural view 390 includes layout modules 391, merchandising modules 392, business modules 393, and processing modules 394.

Modules 391-393 may be adapted to implement the functions of the retail application. Layout modules 391 may include store concept, store capacity, floor plan(s), reference store templates, etc. In some instances, an individual store may be defined by master data that may include basic attributes of a store within the system. Master data may include, for example, a store identifier, description, address, opening date, opening hours, etc. Master data may also include a store's assignment to organizational levels in the system such as sales organization, distribution channels, etc. Merchandise modules 392 may track various product availability metrics such as merchandise in transit from supplier(s), merchandise in stock at distribution center(s), merchandise at other store(s), etc. Merchandise modules may also track merchandise characteristics (e.g., color and size). Business modules 393 include a variety of data used to forecast future sales including historical KPIs, forecast data, planning data, and budget data. Armed with data from one or more of modules 391-393, processing modules 394 may implement the functions of the retail application.

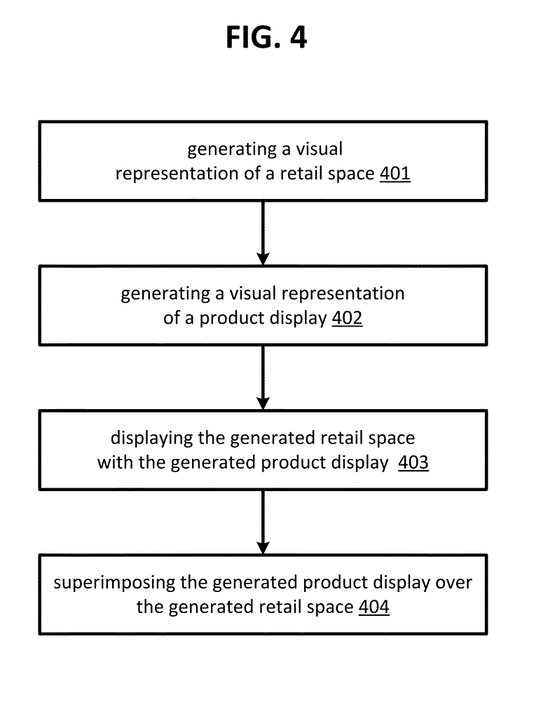

FIG. 4 illustrates a method for displaying a retail space according to an example embodiment of the present disclosure.

At step 401, one or more visualization modules of the portable electronic device generate a visual representation of a retail store. At the outset, the retail application can display a generic retail floor space corresponding to the type of retail store being modeled. Alternatively, the retail application can display a floor space based on the retail store of a specific retailer. In yet another alternative, the retail application may display a floor space based on a reference store. Visualizations of retail space may be stored at the portable electronic device, or may be stored and supplied by the backend system.

Next, at step 402, one or more visualization modules of the portable electronic device generate a visual representation of one or more product displays within the rendered store layout. The visualized product display may be depicted alone or with its associated products. Once a user selects to add one or more products, a menu of product displays can be provided. The variety of product displays can be stored at the portable electronic device, or may be supplied by the backend system. As discussed above, store layouts as well as products and their associated product displays can be changed in response to a user selection.

At step 403, the portable electronic device displays the visual representation of the retail space along with the visual representation of the product display. For example, a menu of potential products can be provided adjacent to the visual representation of the retail space. In another example, the retail application, at step 404, superimposes the visual representation of the product display over the visual representation of the retail space, as illustrated in FIG. 3. Once the product display is superimposed on the retail space, the product display may be moved to various locations within the retail space. In the case of a touch screen interface, a user may simply drag the product display to its desired location.

In some instances, the backend system or the portable electronic device may supply product display attributes at the request of the user. Upon selection of a particular display, attributes, such as, dimensions of the product display, capacity of the product display, price of the product display, an image of the product display, number of shelves, and a list of product display configuration templates associated with the product display can be displayed. When the backend system or the portable electronic device supplies product display attributes, the attributes can be displayed to the user.

In a similar manner, the backend system or the portable electronic device may also supply product information, such as price, manufacturer suggested retail price, turnover rate, an image for the product, a quantity of the product, a quantity for each product display type indicating a number of products that can be displayed per portion of a product display having the product display type, and a quantity of the product that can be displayed per peg. When the backend system or the portable electronic device supplies product information, the product information can be displayed to the user.

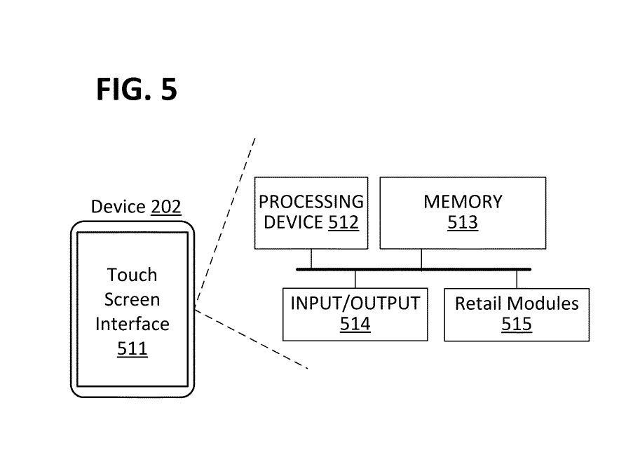

FIG. 5 illustrates a representative architecture of a portable electronic device according to an example embodiment of the present disclosure.

A portable electronic device 202 may include a touch screen interface 511, processing device 512, memory 513, and input/output module 514. The touch screen interface 511 may include a display, which may be a touch screen, capable of displaying data to a user of the portable electronic device 202. Portable electronic device 202 may also include retail application module(s) 515 that generally implements the functionality of the retail application. The components of the retail module 515 are explained in detail with reference to FIG. 2.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor.

Memory 513 may include a computer readable medium storing application modules, which may include instructions associated with applications and modules of the portable electronic device 202.

The input/output module 514 manages the functionality of touch screen interfaced 511. For example, input/output module 514 may include functionality for identifying a touched first point within the retail application displaying a product display. An alternate product display may be selected by dragging the alternate product display onto the existing product display. In another example, different templates may be selected by pressing template buttons displayed by the retail application on touch screen 511.

The portable electronic device may contain a processing device 512, memory 513, and a communications device 225 (as shown in FIG. 2), all of which may be interconnected via a system bus. In various embodiments, the device 202 may have an architecture with modular hardware and/or software systems that include additional and/or different systems communicating through one or more networks via communications device 225.

Communications device 225 may enable connectivity between the processing devices 512 in the device 202 and other systems by encoding data to be sent from the processing device 512 to another system over a network and decoding data received from another system over the network for the processing device 512.

In an embodiment, memory 513 may contain different components for retrieving, presenting, changing, and saving data and may include computer readable media. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system. Memory 513 may be capable of storing user inputs and preferences as well as customized displays and templates. In some instances, a cache in memory 513 may store calculated changes to the profit per square foot based on modifications to product displays.

Processing device 512 may perform computation and control functions of a system and comprises a suitable central processing unit (CPU). Processing device 512 may include a single integrated circuit, such as a microprocessing device, or may include any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the disclosure to the precise forms disclosed. For example, although the processing device 512 is shown as separate from the modules 514 and 515 and the touch screen interface 511, in some instances the processing device 512 and the touch screen interface 511 and/or one or more of the modules 514 and 515 may be functionally integrated to perform their respective functions.

It will be apparent to those skilled in the art that various modifications and variations can be made in the store opening cockpit for real-time preparation, simulation, and execution of merchandise supply for grand opening events of the present disclosure without departing from the spirit or scope of the disclosure. Thus, it is intended that the present disclosure cover the modifications and variations of this disclosure provided they come within the scope of the appended claims and their equivalents.

1. A method comprising:
receiving a selection of one or more store parameters;
receiving a selection of a merchandise template, the merchandise template specifying a product;
displaying a visual representation of a retail space based on at least one selected store parameter and the selected merchandise template;
determining a quantity of the product based on at least one store parameter;
determining availability for the quantity of the product using an in-memory database; and
displaying availability information.

2. The method of claim 1, further comprising:
receiving a modification to one of the store parameters or merchandise template; and
determining updated availability information based on the modification using the in-memory database; and
displaying the updated availability information.

3. The method of claim 2, wherein the merchandise template is modified to specify a different product.

4. The method of claim 1, further comprising:
generating a visual representation of a product display based on the merchandise template, the product display being populated with the product; and
displaying the visual representation of the retail space with the visual representation of the product display.

5. The method of claim 4, wherein the visual representation of the product display is superimposed over the visual representation of the retail space.

6. The method of claim 4, further comprising determining a location of the product display within the retail space.

7. The method of claim 1, further comprising retrieving information for the product, the information for the product including at least one of a price of the product, an image for the product, a manufacturer suggested retail price of the product, a turnover rate for the product, an available quantity of the product, and a quantity for each product display indicating a number of products that can be displayed per product display.

8. The method of claim 1, further comprising:
determining a location of a product display within the retail space;
determining a location of a second product display within the retail space; and
determining availability information for products associated with the product display and the second product display.

9. A non-transitory computer readable storage medium storing one or more programs configured to be executed by a processor, the one or more programs comprising instructions for:
receiving a selection of one or more store parameters;
receiving a selection of a merchandise template, the merchandise template specifying a product;
displaying a visual representation of a retail space based on at least one selected store parameter and the selected merchandise template;
determining a quantity of the product based on at least one store parameter;
determining availability for the quantity of the product using an in-memory database; and
displaying availability information.

10. The non-transitory computer readable storage medium of claim 9, further comprising instructions for:
receiving a modification to one of the store parameters or merchandise template; and
determining updated availability information based on the modification using the in-memory database; and
displaying the updated availability information.

11. The non-transitory computer readable storage medium of claim 10, wherein the merchandise template is modified to specify a different product.

12. The non-transitory computer readable storage medium of claim 9, further comprising instructions for:
generating a visual representation of a product display based on the merchandise template, the product display being populated with the product; and
displaying the visual representation of the retail space with the visual representation of the product display.

13. The non-transitory computer readable storage medium of claim 12, wherein the visual representation of the product display is superimposed over the visual representation of the retail space.

14. The non-transitory computer readable storage medium of claim 12, further comprising instructions for determining a location of the product display within the retail space.

15. The non-transitory computer readable storage medium of claim 9, further comprising instructions for retrieving information for the product, the information for the product including at least one of a price of the product, an image for the product, a manufacturer suggested retail price of the product, a turnover rate for the product, an available quantity of the product, and a quantity for each product display indicating a number of products that can be displayed per product display.

16. The non-transitory computer readable storage medium of claim 9, further comprising instructions for:
determining a location of a product display within the retail space;
determining a location of a second product display within the retail space; and
determining availability information for products associated with the product display and the second product display.

17. A portable electronic device comprising:
one or more process; and
memory storing one or more programs for execution by the one or more processors, the one or more programs including instructions for:
receiving a selection of one or more store parameters;
receiving a selection of a merchandise template, the merchandise template specifying a product;
displaying a visual representation of a retail space based on at least one selected store parameter and the selected merchandise template;
determining a quantity of the product based on at least one store parameter;
determining availability for the quantity of the product using an in-memory database; and
displaying availability information.

18. The portable electronic device of claim 17, further comprising instructions for:
receiving a modification to one of the store parameters or merchandise template; and
determining updated availability information based on the modification using the in-memory database; and
displaying the updated availability information.

19. The portable electronic device of claim 18, wherein the merchandise template is modified to specify a different product.

20. The portable electronic device of claim 17, further comprising instructions for:
generating a visual representation of a product display based on the merchandise template, the product display being populated with the product; and
displaying the visual representation of the retail space with the visual representation of the product display.

21. The portable electronic device of claim 20, wherein the visual representation of the product display is superimposed over the visual representation of the retail space.

22. The portable electronic device of claim 20, further comprising determining a location of the product display within the retail space.

23. The portable electronic device of claim 17, further comprising instructions for retrieving information for the product, the information for the product including at least one of a price of the product, an image for the product, a manufacturer suggested retail price of the product, a turnover rate for the product, an available quantity of the product, and a quantity for each product display indicating a number of products that can be displayed per product display.

24. The portable electronic device of claim 17, further comprising instructions for:
determining a location of a product display within the retail space;
determining a location of a second product display within the retail space; and
determining availability information for products associated with the product display and the second product display.
